(19) United States
(12) Patent Application Publication
(10) Pub. No.: US 2010/0155211 A1
(43) Pub. Date: Jun. 24, 2010

(54) SNAP SWITCH

(75) Inventor: Frank Mark Domzalski, Wellesley, MA (US)

Correspondence Address: PEPPER HAMILTON LLP, ONE MELLON CENTER, 50TH FLOOR, 500 GRANT STREET, PITTSBURGH, PA, 15219, US

(73) Assignee: COACTIVE TECHNOLOGIES, INC., Newton, MA (US)

(21) Appl. No.: 12/342,748

(22) Filed: Dec. 23, 2008

(51) Int. Cl. H01H 5/14

(52) U.S. Cl. 200/408

(57) ABSTRACT

A snap switch may include a housing, a lever having a handle portion and a base portion, a contact component having a first contact and a spring having a first end and a second end. The first end may be secured to the housing, the second end may be secured to the contact component, and a base portion of the lever may surround at least a first portion of the spring. The snap switch may include a first terminal component that may have a first prong and a second prong that may define an opening through which a second portion of the spring may be received. The snap switch may include a second terminal component that may have a second contact.

### BACKGROUND

Snap switches, such as those used in fluid sensing level applications, usually require the switching mechanism to travel a distance between an “on” position and an “off” position. This distance can assist in preventing false switch actuations due to, for example, slow or turbulent changes in the fluid level that cause minor movement of the switch trigger but which are not desired to actuate the switch.

A double break butterfly design switch is commonly used in fluid level applications. An exemplary butterfly switch assembly is shown in U.S. Pat. No. 4,973,808. However, butterfly designs tend to have high material and manufacturing costs. In addition, the contact pivot point of a double break switch can suffer extensive wear and tear, and an actuation force is often difficult to achieve and control using a double break switch.

### SUMMARY

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

In an embodiment, a snap switch may include a housing, a lever having a handle portion and a base portion, a contact component having a first contact and a spring having a first end and a second end. The first end may be secured to the housing, the second end may be secured to the contact component, and a base portion of the lever may surround at least a first portion of the spring. The snap switch may include a first terminal component that may have a first prong and a second prong that may define an opening through which a second portion of the spring may be received. The snap switch may include a second terminal component that may have a second contact.

In an embodiment, a method of using a snap switch may include moving a handle of a lever of a snap switch from a first position to a second position, where the lever may have a base portion and the snap switch may include a housing, a contact component having a first contact and a spring having a first end and a second end. The first end may be secured to the housing, the second end may be secured to the contact component, and the base portion of the lever may surround at least a first portion of the spring. The snap switch may include a first terminal component having a first prong and a second prong that may define an opening, through which a second portion of the spring may be received, and a second terminal component comprising a second contact. The method may include, in response to moving the handle from the first position to the second position, moving, by the base of the lever, a substantially center portion of the spring from a third position to a fourth position.

in response to moving the substantially center portion of the spring from the third position to the fourth position, moving, by the spring, the contact component from a fifth position to a sixth position.

In an embodiment, a snap switch may include a housing, a push button moveably connected to the housing, a contact component having a first contact, and a spring having a first end and a second end. The first end may be secured to the housing, the second end may be secured to the contact component, and a base portion of the push button may surround at least a first portion of the spring. The snap switch may include a first terminal component having a first prong and a second prong that may define an opening through which the second portion of the spring may be received, and a second terminal component having a second contact.

In an embodiment, a method of using a snap switch may include moving a push button of a snap switch from a first position to a second position. The push button may include a base portion, and the snap switch may include a housing, a contact component having a first contact and a spring having a first end and a second end. The first end may be secured to the housing, the second end may be secured to the contact component, and the base portion of the push button may surround at least a first portion of the spring. The snap switch may include a first terminal component having a first prong and a second prong, where the first prong and the second prong may define an opening, through which a second portion of the spring may be received, and a second terminal component having a second contact. The method may include, in response to moving the push button from the first position to the second position, moving, by the base portion of the push button, a substantially center portion of the spring from a third position to a fourth position. The method may include, in response to moving the substantially center portion of the spring from the third position to the fourth position, moving, by the spring, the contact component from a fifth position to a sixth position.

### BRIEF DESCRIPTION OF THE DRAWINGS

Aspects, features, benefits and advantages of the present invention will be apparent with regard to the following description and accompanying drawings, of which:

FIG. 1 illustrates an exemplary snap switch according to an embodiment.

FIG. 2A illustrates an exemplary lever according to an embodiment.

FIG. 2B illustrates an exemplary base portion of a lever according to an embodiment.

FIG. 3 illustrates an exemplary spring according to an embodiment.

FIG. 4A illustrates an exemplary spring and contact component according to an embodiment.

FIG. 4B illustrates a side view of an exemplary contact component according to an embodiment.

FIG. 4C illustrates a side view of an exemplary contact component according to an embodiment.

FIG. 5 illustrates an exemplary first terminal component according to an embodiment.

FIG. 6 illustrates an exemplary second terminal component according to an embodiment.

FIG. 7 illustrates an exemplary method of using a snap switch according to an embodiment.

FIG. 8A illustrates an exemplary snap switch according to an embodiment.

FIG. 8B illustrates an exemplary push button according to an embodiment.

FIG. 9 illustrates an exemplary method of using a snap switch according to an embodiment.

FIG. 10A illustrates an exemplary snap switch according to an embodiment.

FIG. 10B illustrates an exemplary snap switch according to an embodiment.

### DETAILED DESCRIPTION

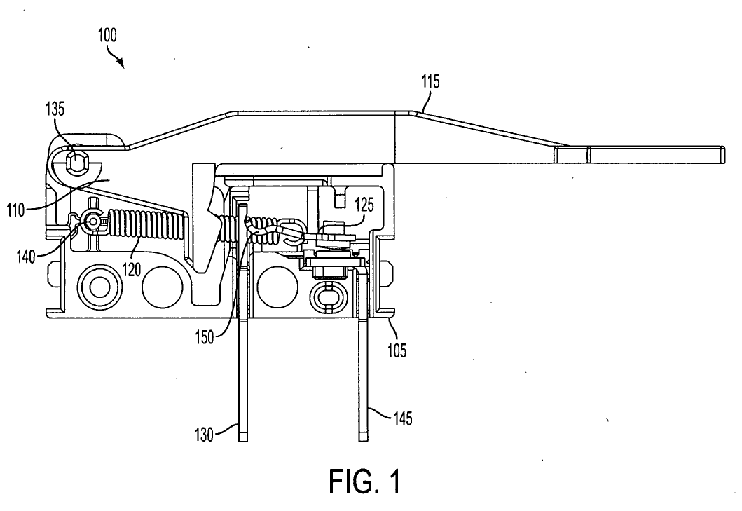

FIG. 1 illustrates an exemplary snap switch according to an embodiment. As illustrated by FIG. 1, a snap switch 100 may include a housing 105, a cover 110, a lever 115, a spring 120, a contact component 125 and a first terminal component 130 and/or a second terminal component 145.

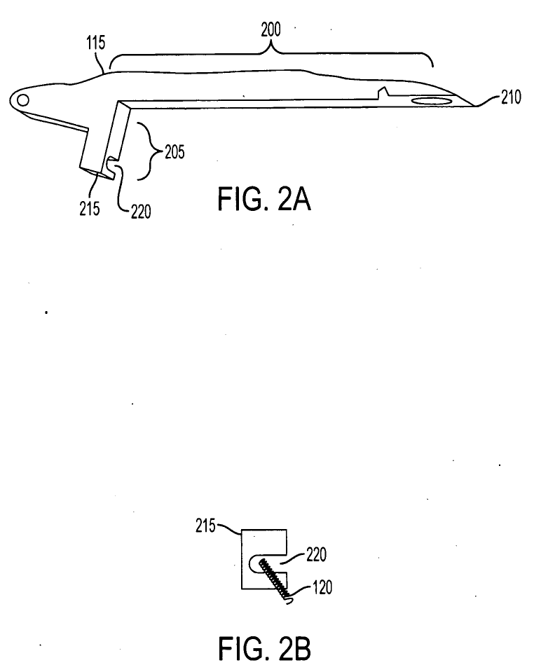

In an embodiment, the lever 115 may be moveably connected to the housing 105 at a pivot point 135. The pivot point 135 may be an axle, pin, groove or other structure about which the lever 115 may at least partially rotate. As illustrated by FIG. 2A, the lever 115 may comprise a first portion 200 and a second portion 205. The first portion 200 may comprise a handle 210 configured to be moved from a first position to a second position. In an embodiment, the distance between the first position and the second position may be approximately 0.102-0.15 inches.

The second portion 205 of the lever 115 may comprise a base 215. The base 215 may define an opening 220 that may surround a portion of the spring 120 as illustrated by FIG. 2B. In an embodiment, the lever 115 may be fabricated from nylon and/or other similar materials.

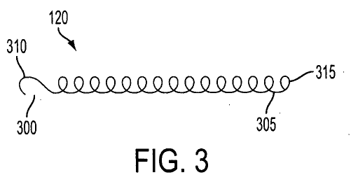

FIG. 3 illustrates an exemplary spring 120 that may be used in a snap switch 100 according to an embodiment. As illustrated by FIG. 3, the spring 120 may have a first end 300 and a second end 305. The first end 300 may comprise a first hook portion 310, and the second end 305 may comprise a second hook portion 315. In an embodiment, the first end 300 of the spring 120 may be secured to the housing 105. For example, as illustrated by FIG. 1, the first end 300 of the spring 120 may be secured to a protrusion 140 from the housing 105 via the first hook portion 310. In an embodiment, the spring 120 may be fabricated from stainless steel, other metals and/or other metal alloys.

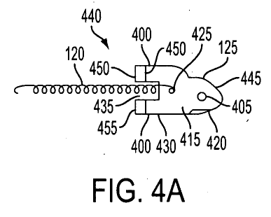

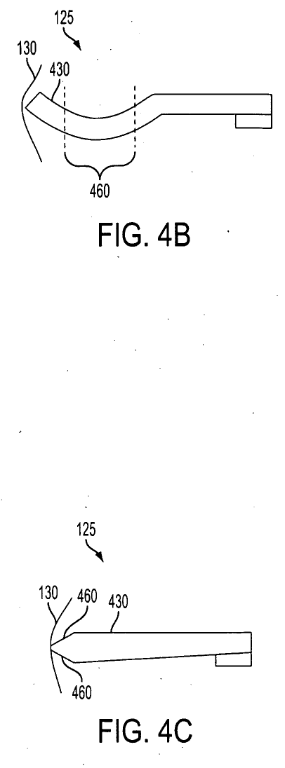

FIG. 4A illustrates an exemplary spring 120 and contact component 125 according to an embodiment. As illustrated by FIG. 4A, the contact component 125 may have a first end 440 and a second end 445. The first end 440 may include two prongs 400, 430. The prongs 400, 430 may define a passageway 435 between them. In an embodiment, the passageway 435 may receive the second end 305 of the spring 120.

In an embodiment, the prongs 400, 430 may be substantially straight. Alternatively, at least a portion 460 of each prong 400, 430 may be angled relative to another portion of the prong. For example, as illustrated by FIG. 4B and FIG. 4C, the angled portion 460 may be substantially rounded, pointed, rectangular and/or the like. Additional and/or alternate angled portions 460 may be used within the scope of this disclosure. In an embodiment, the angled portion 460 of one prong 400 may be located at relatively the same position as the angled portion 150 on the other prong 430.

The contact component 125 may include a first surface 415 and a second surface 420. In an embodiment, the first surface 415 may be a top surface and the second surface 420 may be a bottom surface. In an embodiment, a first passageway 425 may extend from the first surface 415 through the second surface 420. As illustrated by FIG. 4A, the spring 120 may be secured to the contact component 125 via the first passageway 425. For example, the second hook portion 315 of the spring 120 may be attached to the first passageway 425 of the contact component 125.

In an embodiment, the contact component 125 may comprise a second passageway 405 extending from the first surface 415 through the second surface 420. One or more contacts may be secured to the contact component 125 via the second passageway 405. For example, a contact may be integrally formed to the second passageway 405 on the first surface 415 and/or the second surface 420. Alternatively, a contact may be removeably connected to the second passageway 405 on the first surface 415 and/or the second surface 420. In an embodiment, the contact component 125 and or the contact may be fabricated from copper alloy, silver nickel, silver plate and/or any other metals, metal alloys or plating configurations.

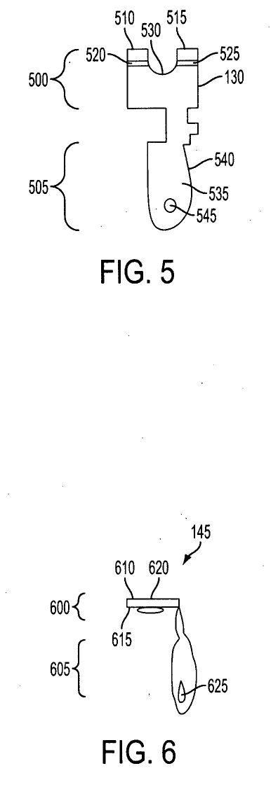

In an embodiment, a first terminal component 130 may be located between the spring 120 and the contact component 125. As illustrated by FIG. 5, the first terminal component 130 may comprise a top portion 500 and a bottom portion 505. The top portion 500 may comprise two prongs 510, 515 which may define a passageway 530 between them. In an embodiment, each prong 510, 515 may have at least one groove 520, 525. In an embodiment, the first terminal component 130 may be fabricated from copper alloy and/or any other metals, metal alloys or plating configurations. In an embodiment, at least a portion of the spring 120 may be received by the passageway 520 between the two prongs 510, 515 of the first terminal component 130.

In an embodiment, each end 450, 455 of the prongs 400, 430 may connect to a groove 520, 525 of a first terminal component prong 510, 515 as illustrated by FIG. 5. In an embodiment, the ends 450, 455 may be connected to the first terminal component prongs 510, 515 by a force exerted by the spring 120. Alternatively, the ends 450, 455 may be integrally formed with the first terminal component prongs 510, 515.

In embodiment, the bottom portion 505 of the first terminal piece 130 may comprise a first surface 535 and a second surface 540. An opening 545 may pass through the first surface 535 and the second surface 540 as illustrated by FIG. 5. The opening 545 may be used to secure wires or other electrical connections to the first terminal component 130.

In an embodiment, a second terminal component 145 may comprise a top portion 600 and a bottom portion 605 as illustrated by FIG. 6. The top portion may comprise a first surface 610 and a second surface 615. A passageway 620 may extend from the first surface 610 through the second surface 615. In an embodiment, the second terminal component 145 may be fabricated from copper alloy and/or any other metals, metal alloys or plating configurations.

In an embodiment, one or more contacts may be secured to the top portion 600 via the passageway 620. For example, a contact may be integrally formed to the passageway 620 on the first surface 610 and/or the second surface 615. Alternatively, a contact may be removeably connected to the passageway 620 on the first surface 610 and/or the second surface 615.

In an embodiment, the bottom portion 605 of the second terminal component 145 may include a second passageway 625. The second passageway 625 may be used to secure wires or other electrical connections to the second terminal component 145.

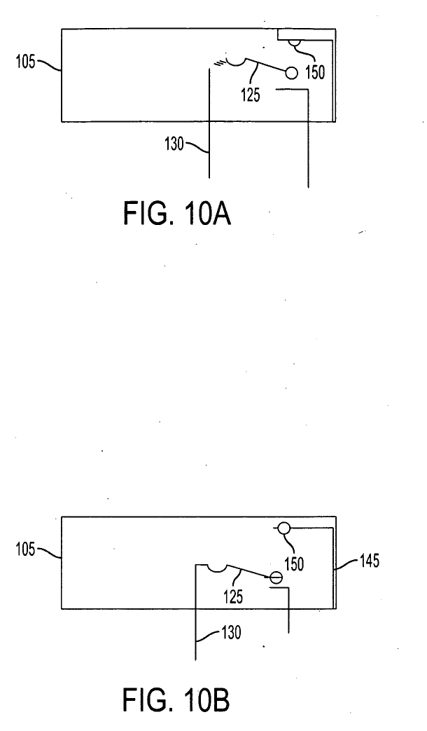

In an alternate embodiment, a contact 150 may be located on a portion of the housing 105 located above the second end 445 of the contact component 125 as illustrated by FIG. 10A. For example, as illustrated by FIG. 10A, a contact 150 may be secured to a portion of the housing 105, such as a ledge, a top portion of the housing and/or the like. In an embodiment, the contact component 125 may move between a first position, for example, that of being in physical contact with the contact 150, to a second position, for example, that of being separated from the contact 150.

In an alternate embodiment, the second terminal component 145 may be located such that its contact may be located above the second end 445 of the contact component 125 as illustrated by FIG. 10B. In an embodiment, the contact component 125 may move between a first position, for example, that of being in physical contact with the contact of the second terminal component 145, to a second position, for example, that of being separated from the contact of the second terminal component.

Additional and/or alternate contact locations may be used within the scope of this disclosure. In an embodiment, the contact 150 may be fabricated from silver-nickel, gold-plate and/or any other metals, metal alloys or plating configurations.

In an embodiment, a cover 110 may secure one or more components of the snap switch 100. The cover 110 may be removeably connected to the housing 105, the lever 115 and/or the like. In an embodiment, the cover 110 may be integrally formed with the housing 105, the lever 115 and/or the like.

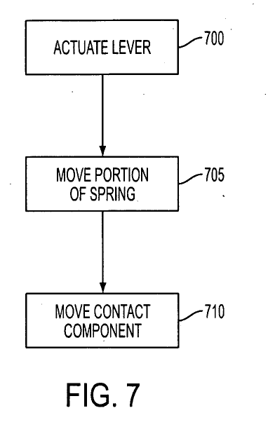

FIG. 7 illustrates an exemplary method of using a snap switch 100 according to an embodiment. In an embodiment, a lever 115 may be actuated 700 by its handle 210 being moved from a first position to a second position. The handle 210 of the lever 115 may be manually actuated 700 or it may be actuated 700 in response to a stimulus, such as a rising water level and/or the like. Actuating 700 the handle 210 may cause a portion of the spring 120 to move 705. In an embodiment, actuating 700 the handle 210 may cause the base 215 of the lever 115 to move a substantially center portion of the spring 120 from a first position to a second position. For example, moving the handle 210 downwards may cause the base 215 of the lever 115 to move a substantially center portion of the spring 120 downwards.

In an embodiment, movement of the spring 120 may, in turn, trigger movement of the contact component 125. For example, moving the handle 210 downwards may cause the base 215 of the lever 115 to move a substantially center portion of the spring 120 downwards. This movement may cause the contact component 125 to also move 710 downwards, thus allowing it to come into contact with the second terminal component 145. Similarly, moving 700 the lever upwards may cause a portion of the spring 120 to move 705 upwards, which, in turn, may cause the contact component 125 to move 710 upwards and out of contact with the second terminal component 145.

In an embodiment, the lever 115 may be configured to move or travel for a limited distance without causing actuation of the spring 120 and/or contact component 125. For example, the lever 115 may need to travel at least a specific distance to actuate the lever 115 thus causing movement of the spring 120 and/or contact component 125. Movement of the lever at any distance less than this distance may not actuate the spring 120 and/or contact component 125. For example, slow or turbulent changes in a fluid level may cause minor movement of the lever 115, however repeated actuation may be avoided when the distance associated with the movement is less than the specific distance needed to actuate the lever.

In an embodiment, the contact component 125 may maintain its position until the lever 115 is actuated 700. For example, once the lever 115 has been moved to a “down” position, the contact component 125 may maintain a “down” position until the lever is actuated 700 to an “up” position. Similarly, once the lever 115 has been moved to an “up” position, the contact component 125 may maintain this position until the lever is actuated 700 to a “down” position.

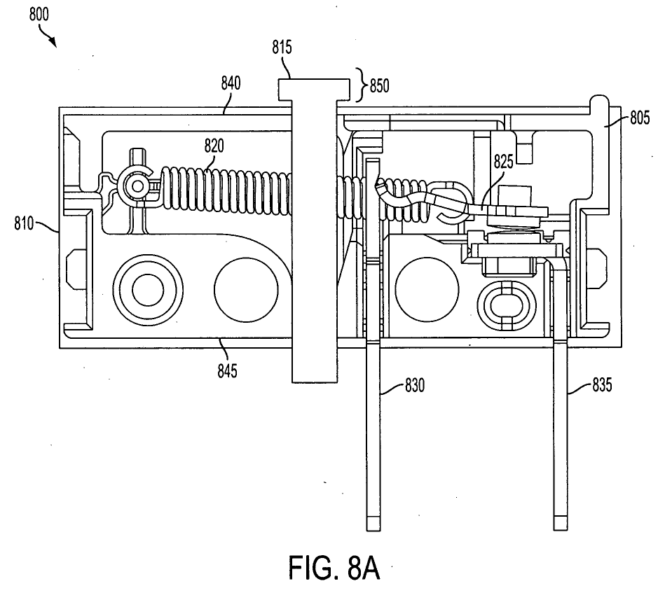

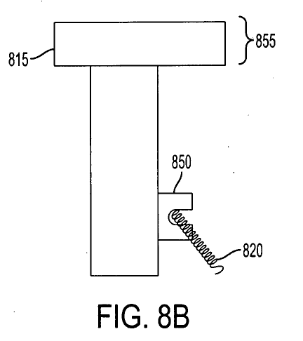

In an embodiment, a snap switch may include a push button. FIG. 8A illustrates an exemplary snap switch 800 having a housing 805, a cover 810, a push button 815, a spring 820, a contact component 825, a first terminal component 830 and/or a second terminal component 835.

In an embodiment, the push button 815 may be moveably connected to the housing 805. In an embodiment, the push button may include a top portion 855 and a base portion 850. The base portion 850 of the push button 815 may surround at least a substantially center portion of the spring 820 as illustrated by FIG. 8B. In an embodiment, the push button 815 may extend from a first surface 840 of the housing 805 through a second surface 845 of the housing as illustrated by FIG. 8A.

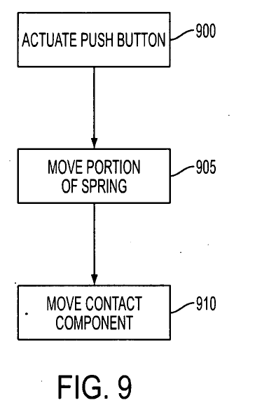

FIG. 9 illustrates an exemplary method of using a snap switch according to an embodiment. In an embodiment, a push button 815 may be actuated 900 by moving the push button from a first position to a second position. The push button 815 may be manually actuated 900 or it may be actuated in response to a stimulus, such as a rising or falling water level and/or the like. Actuating 900 the push button 815 may cause a portion of the spring 820 to move 905. In an embodiment, actuating 900 the push button 815 may cause a substantially center portion of the spring 820 to move 905 from a first position to a second position. For example, pushing the push button 815 may cause a substantially center portion of the spring 820 to move 905 downwards.

In an embodiment, movement of the spring 820 may, in turn, trigger movement of the contact component 825. For example, pushing the push button 815 may move 905 a substantially center portion of the spring 820 downwards. This movement may cause the contact component 825 to also move 910 downwards, thus allowing it to come into contact with the second terminal component 835. Similarly, pushing the push button 815 another time may cause a portion of the spring 820 to move 905 upwards, which, in turn, may cause the contact component 825 to move 910 upwards and out of contact with the second terminal component 835.

In an embodiment, the push button 815 may maintain its position until it is actuated. For example, once the push button has been pushed to a “down” position, it may maintain this position until is it actuated to an “up” position. Similarly, once the push button 815 has been moved to an “up” position, it may maintain this position until it is actuated to a “down” position.

In an embodiment, a snap switch may be used in conjunction with a pump. For example, a snap switch may be used to turn a pump on and/or off based on a water level. In an embodiment, a snap switch may be in electrical contract with a pump via one or more wires and/or other electrical connections. In an embodiment, a water level may rise sufficiently to actuate the lever of the snap switch by moving the lever from a first position to a second position. This movement may cause the contact component to move into electrical contact with second terminal component, which may, in turn, cause the pump to turn on. Similarly, when the water level subsides, it may move the lever from a second position to a first position. This movement may cause the contact component to move out of electrical contact with the second terminal component, which may, in turn, cause the pump to turn off.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A snap switch comprising:
a housing;
a lever comprising a handle portion and a base portion;
a contact component comprising a first contact;
a spring comprising a first end and a second end, wherein the first end is secured to the housing, wherein the second end is secured to the contact component, wherein the base portion of the lever surrounds at least a first portion of the spring;
a first terminal component comprising a first prong and a second prong, wherein the first prong and the second prong define an opening, wherein a second portion of the spring is received through the opening; and
a second terminal component comprising a second contact.

2. The snap switch of claim 1, wherein the handle portion of the lever is configured to move between a first position and a second position, wherein movement of the lever from the first position to the second position causes the base portion to move a portion of the spring, wherein movement of the spring causes movement of the contact component.

3. The snap switch of claim 1, wherein the contact component comprises a first prong having a first end and a second prong having a second end, wherein the first end is received by a first groove on the first prong of the first terminal component, wherein the second end is received by a second groove on the second prong of the second terminal component.

4. The snap switch of claim 1, wherein the contact component comprises a first passageway extending from a first surface of the contact component through a second surface of the contact component.

5. The snap switch of claim 4, wherein the second end of the spring comprises a hook portion configured to connect to the first passageway.

6. The snap switch of claim 1, wherein the first end of the spring is secured to the housing via a hook portion located at the first end of the spring.

7. The snap switch of claim 1, wherein one or more of the first terminal component and the second terminal component comprise a bottom portion having a passageway.

8. The snap switch of claim 1 further comprising a cover removeably connected to the housing, wherein the housing surrounds one or more of the lever, the contact component, the spring, the first terminal component and the second terminal component.

9. The snap switch of claim 1, wherein the first contact component comprises a top surface and a bottom surface, wherein the first contact is removeably connected to the contact component, where in at least a portion of the first contact extends below the bottom surface.

10. The snap switch of claim 1, wherein the first contact component comprises a top surface and a bottom surface, wherein the first contact is integrally formed with the contact component, wherein at least a portion of the first contact extends below the bottom surface.

11. The snap switch of claim 1, wherein the second terminal component comprises a top portion and a bottom portion, wherein the second contact is secured to the top portion of the second terminal component.

12. The snap switch of claim 1, wherein:
the lever is configured to be moved from a first position to a second position;
a substantially center portion of the spring is configured to be moved by the lever from a third position to a fourth position; and
the contact component is configured to be moved by the spring from a fifth position to a sixth position.

13. The snap switch of claim 1, wherein the housing comprises:
a third contact secured to the housing at a location above the first contact.

14. The snap switch of claim 1, wherein the lever is secured to the housing at a pivot point.

15. A method of using a snap switch, the method comprising:
moving a handle of a lever of a snap switch from a first position to a second position, wherein the lever comprises a base portion, wherein the snap switch comprises:
a housing,
a contact component comprising a first contact,
a spring comprising a first end and a second end, wherein the first end is secured to the housing, wherein the second end is secured to the contact component, wherein the base portion of the lever surrounds at least a first portion of the spring,
a first terminal component comprising a first prong and a second prong, wherein the first prong and the second prong define an opening, wherein a second portion of the spring is received through the opening, and
a second terminal component comprising a second contact;
in response to moving the handle from the first position to the second position, moving, by the base of the lever, a substantially center portion of the spring from a third position to a fourth position; and
in response to moving the substantially center portion of the spring from the third position to the fourth position, moving, by the spring, the contact component from a fifth position to a sixth position.

16. The method of claim 15, wherein:
moving a handle of a lever of a snap switch from a first position to a second position comprises moving the handle from a first up position to a first down position;
moving, by the base of the lever, a substantially center portion of the spring from a third position to a fourth position comprises moving the substantially center portion of the spring from second up position to a second down position; and
moving, by the spring, the contact component from a fifth position to a sixth position comprises moving the contact component from a third up position to a third down position.

17. The method of claim 15, wherein:
moving a handle of a lever of a snap switch from a first position to a second position comprises moving the handle from a first down position to a first up position;
moving, by the base of the lever, a substantially center portion of the spring from a third position to a fourth position comprises moving the substantially center portion of the spring from second down position to a second up position; and
moving, by the spring, the contact component from a fifth position to a sixth position comprises moving the contact component from a third down position to a third up position.

18. The method of claim 15, wherein moving a handle of a lever of a snap switch from a first position to a second position comprises one or more of the following:
manually moving a handle of a lever of a snap switch from a first position to a second position; and
moving, by a stimulus, a handle of a lever of a snap switch from a first position to a second position.

19. A snap switch comprising:
a housing;
a push button moveably connected to the housing;
a contact component comprising a first contact;
a spring comprising a first end and a second end, wherein the first end is secured to the housing, wherein the second end is secured to the contact component, wherein a base portion of the push button surrounds at least a first portion of the spring;
a first terminal component comprising a first prong and a second prong, wherein the first prong and the second prong define an opening, wherein a second portion of the spring is received through the opening; and
a second terminal component comprising a second contact.

20. The snap switch of claim 19, wherein the push button is configured to move between a first position and a second position, wherein movement of the push button from the first position to the second position causes the base portion of the push button to move a portion of the spring, wherein movement of the spring causes movement of the contact component.

21. A method of using a snap switch, the method comprising:
moving a push button of a snap switch from a first position to a second position, wherein the push button comprises a base portion, wherein the snap switch comprises:
a housing,
a contact component comprising a first contact,
a spring comprising a first end and a second end, wherein the first end is secured to the housing, wherein the second end is secured to the contact component, wherein the base portion of the push button surrounds at least a first portion of the spring,
a first terminal component comprising a first prong and a second prong, wherein the first prong and the second prong define an opening, wherein a second portion of the spring is received through the opening, and
a second terminal component comprising a second contact;
in response to moving the push button from the first position to the second position, moving, by the base portion of the push button, a substantially center portion of the spring from a third position to a fourth position; and
in response to moving the substantially center portion of the spring from the third position to the fourth position, moving, by the spring, the contact component from a fifth position to a sixth position.
